(19) United States
(12) Patent Application Publication
(10) Pub. No.: US 2025/0383657 A1
(43) Pub. Date: Dec. 18, 2025

(54) DOMAIN GENERALIZATION MODELLING METHOD, APPARATUS, DEVICE AND MEDIUM FOR INDUSTRIAL EQUIPMENT HEALTH PREDICTION

(71) Applicant: BEIHANG UNIVERSITY, Beijing (CN)

(72) Inventors: Lei REN, Beijing (CN); Zidi JIA, Beijing (CN)

(21) Appl. No.: 19/000,409

(22) Filed: Dec. 23, 2024

(30) Foreign Application Priority Data
Jun. 17, 2024 (CN) 202410774363.4

(51) Int. Cl. G05B 23/02

(52) U.S. Cl. CPC G05B 23/0283

(57) ABSTRACT

The present application provides a domain generalization modelling method, apparatus, device, and medium for industrial equipment health prediction. Multiple pieces of source domain data are inputted into a shared feature extractor to obtain a shared feature corresponding to each piece of source domain data; multiple shared features are inputted into a shared predictor to obtain a predicted health indicator corresponding to each piece of source domain data; a health task loss for the multiple pieces of source domain data is determined according to multiple predicted health indicators; similarity processing is performed on the multiple shared features to obtain a similarity loss for the multiple pieces of source domain data. Based on the health task loss and the similarity loss, update and iteration processing is performed on the shared feature extractor and the shared predictor to obtain a target feature extractor and a target predictor to construct a health prediction model.

### CROSS-REFERENCE TO RELATED APPLICATION

This application claims priority to Chinese Patent Application No. 202410774363.4, filed on Jun. 17, 2024, which is hereby incorporated by reference in its entirety.

### TECHNICAL FIELD

The present application relates to the technical field of industrial time series prediction, and in particular, to a domain generalization modelling method, apparatus, device and medium for industrial equipment health prediction.

### BACKGROUND

Accurate prediction of industrial equipment health relates to reliability of industrial production, which can effectively avoid safety hazards and economic losses, and one of the most important tasks is industrial time series prediction. Industrial time series prediction refers to using a large amount of collected data to predict certain key performance indicators of a process to provide support for industrial process monitoring, model identification, fault diagnosis and prediction, etc., which has important theoretical significance and application value.

At present, industrial time series prediction, as an important part of industrial intelligence, has received widespread attention since its inception. In order to realize industrial intelligence, it is crucial to properly apply novel AI-based industrial time series prediction techniques.

However, most of the aforementioned industrial equipment health prediction methods face the following unsolved problems. The working conditions of industrial equipment are usually variable, which leads to the assumption of independent identical distribution of monitoring data not being valid, and due to the unknown working conditions, it is difficult to obtain data under the corresponding working conditions to train or fine-tune the model. Although there have been many relatively mature domain generalization methods, most of them are for classification tasks, and very few of them are developed for regression prediction tasks, and hence, most of the transfer learning methods cannot be applied to regression tasks. Domain generalization models may be sensitive to extremely distributed samples, and such extreme samples will reduce the effect of domain generalization and the accuracy of the model. Therefore, the above mentioned problems faced by industrial equipment health prediction methods need to be solved urgently.

### SUMMARY

The present application provides a domain generalization modelling method, apparatus, device and medium for industrial equipment health prediction to solve the above problems in the prior art, namely, working conditions of industrial equipment in the prior art are usually variable, which results in the assumption of independent identical distribution of the monitoring data not being valid, and due to the unknown nature of the working conditions, it is therefore difficult to obtain data under the corresponding working conditions for training or fine-tuning the model; although there are many relatively mature domain generalization methods, most of these methods are for classification tasks, and very few are developed for regression forecasting tasks, and hence, most of the transfer learning methods cannot be applied to regression tasks; the domain generalization model may be sensitive to the extremely distributed samples, and such extreme samples may reduce the effect of the domain generalization and the accuracy of the model.

In a first aspect, the present application provides a domain generalization modelling method for industrial equipment health prediction, the method including:
obtaining multiple pieces of source domain data to be predicted, and inputting the multiple pieces of source domain data into a shared feature extractor to obtain a shared feature corresponding to each piece of source domain data, where industrial environments of the multiple pieces of source domain data are different;
inputting multiple shared features into a shared predictor to obtain a predicted health indicator corresponding to each piece of source domain data;
determining, according to multiple predicted health indicators, a health task loss for the multiple pieces of source domain data;
performing similarity processing on the multiple shared features to obtain a similarity loss for the multiple pieces of source domain data; and
performing, according to the multiple pieces of source domain data, based on the health task loss and the similarity loss, update and iteration processing on the shared feature extractor and the shared predictor to obtain a target feature extractor and a target predictor, and constructing a health prediction model according to the target feature extractor and the target predictor.

Optionally, the determining, based on the multiple predicted health indicators, the health task loss for the multiple pieces of source domain data includes:
obtaining actual health indicators corresponding to the multiple pieces of source domain data;
determining, according to the multiple predicted health indicators and multiple actual health indicators, a prediction bias and a covariance corresponding to each piece of source domain data;
performing variance solving processing on prediction biases and covariances corresponding to the multiple pieces of source domain data to obtain a risk extrapolation parameter corresponding to the multiple pieces of source domain data; and
determining, according to the risk extrapolation parameter and the covariances corresponding to the multiple pieces of source domain data, the health task loss for the multiple pieces of source domain data.

Optionally, the performing similarity processing on the multiple shared features to obtain the similarity loss for the multiple pieces of source domain data includes:
determining, using the following formula, the similarity loss for the multiple pieces of source domain data:

$${ℒ}_{similarity} = - log {\sum }_{i} [ \frac{{\sum }_{k \neq i} exp ( - τ \vert {y}_{i} - {y}_{k} \vert ) ‖ {H}_{i}^{{S}^{T}} {H}_{k}^{S} ‖}{{\sum }_{j \neq i} exp ( - τ \vert {y}_{i} - {y}_{j} \vert )} + ε ]$$

where [symbol] _{similarity} is the similarity loss for the multiple pieces of source domain data, k is a number of source domains of the multiple pieces of source domain data, yᵢ is an actual health indicator of the multiple pieces of source domain data corresponding to the i-th source domain data, yⱼ is an actual health indicator of the multiple pieces of source domain data corresponding to the j-th source domain data, yₖ is an actual health indicator of the multiple pieces of source domain data corresponding to the k-th source domain data,

$${H}_{i}^{S}$$

is used for indicating a shared feature of the multiple pieces of source domain data corresponding to the i-th source domain data,

$${H}_{k}^{S}$$

is used for indicating a shared feature of the multiple pieces of source domain data corresponding to the k-th source domain data, and τ and ε are hyperparameters determined through experiment.

Optionally, before performing, according to the multiple pieces of source domain data, based on the health task loss and the similarity loss, update and iteration processing on the shared feature extractor and the shared predictor to obtain the target feature extractor and the target predictor, the method further includes:
inputting the multiple pieces of source domain data into a private feature extractor to obtain a private feature corresponding to each piece of source domain data;
inputting multiple private features and the multiple shared features into a generator to obtain reconstructed data corresponding to the multiple pieces of source domain data;
determining, according to the reconstructed data and the multiple pieces of source domain data, a reconstruction loss for the multiple pieces of source domain data;
where the performing, according to the multiple pieces of source domain data, based on the health task loss and the similarity loss, update and iteration processing on the shared feature extractor and the shared predictor to obtain the target feature extractor and the target predictor includes:
performing, according to the multiple pieces of source domain data, based on the health task loss, the similarity loss and the reconstruction loss, update and iteration processing on the shared feature extractor and the shared predictor to obtain the target feature extractor and the target predictor.

Optionally, the determining, according to the reconstructed data and the multiple pieces of source domain data, the reconstruction loss for the multiple pieces of source domain data includes:
determining, using the following equation, the reconstruction loss for the multiple pieces of source domain data:

$${ℒ}_{reconstruct} = {\sum }_{k = 1}^{K} \frac{1}{m} {‖ {X}_{k} - {\hat{X}}_{k} ‖}_{2}^{2} + \frac{1}{{m}^{2}} {( ( {X}_{k} - {\hat{X}}_{k} ) \cdot {1}_{m} )}^{2}$$

where [symbol] _{reconstruct} is the reconstruction loss for the multiple pieces of source domain data, K is a number of source domains of the multiple pieces of source domain data, m is a sequence length of each piece of source domain data, lₘ is a column vector with a length of m and all elements being 1, Xₖ is actual data of the multiple pieces of source domain data corresponding to the k-th source domain, and \hat{X}ₖ is reconstructed data of the multiple pieces of source domain data corresponding to the k-th source domain.

Optionally, before performing, according to the multiple pieces of source domain data, based on the health task loss and the similarity loss, update and iteration processing on the shared feature extractor and the shared predictor to obtain the target feature extractor and the target predictor, the method further includes:
performing diversity processing on the multiple private features and the multiple shared features to obtain a diversity loss corresponding to the multiple pieces of source domain data;
where the performing, according to the multiple pieces of source domain data, based on the health task loss and the similarity loss, update and iteration processing on the shared feature extractor and the shared predictor to obtain the target feature extractor and the target predictor includes:
performing, according to the multiple pieces of source domain data, based on the health task loss, the similarity loss, the reconstruction loss and the diversity loss, update and iteration processing on the shared feature extractor and the shared predictor to obtain the target feature extractor and the target predictor.

Optionally, the performing, according to the multiple pieces of source domain data, based on the health task loss, the similarity loss, the reconstruction loss and the diversity loss, update and iteration processing on the shared feature extractor and the shared predictor to obtain the target feature extractor and the target predictor includes:
performing, using the health task loss, the similarity loss, the reconstruction loss, and the diversity loss, update processing on the shared feature extractor to obtain an updated shared feature extractor;
performing, according to the multiple pieces of source domain data, iterative training on the updated shared feature extractor until iteration is completed, to obtain the target feature extractor;
performing, using the health task loss, update processing on the shared predictor to obtain an updated shared predictor; and
performing, according to the multiple pieces of source domain data, iterative training on the updated shared predictor until iteration is completed, to obtain the target predictor.

In a second aspect, the present application provides a domain generalization modelling apparatus for industrial equipment health prediction, and the apparatus includes:
an obtaining module, configured to obtain multiple pieces of source domain data to be predicted, and input the multiple pieces of source domain data into a shared feature extractor to obtain a shared feature corresponding to each piece of source domain data, where industrial environments of the multiple pieces of source domain data are different;
an input module, configured to input multiple shared features into a shared predictor to obtain a predicted health indicator corresponding to each piece of source domain data;
a determining module, configured to determine, according to multiple predicted health indicators, a health task loss for the multiple pieces of source domain data; and
a processing module, configured to perform similarity processing on the multiple shared features to obtain a similarity loss for the multiple pieces of source domain data;
where the processing module is further configured to perform, according to the multiple pieces of source domain data, based on the health task loss and the similarity loss, update and iteration processing on the shared feature extractor and the shared predictor to obtain a target feature extractor and a target predictor, and constructing a health prediction model according to the target feature extractor and the target predictor.

Optionally, the obtaining module is further configured to obtain actual health indicators corresponding to the multiple pieces of source domain data;
the determining module is further configured to determine, according to the multiple predicted health indicators and multiple actual health indicators, a prediction bias and a covariance corresponding to each piece of source domain data;
the processing module is further configured to perform variance solving processing on prediction biases and covariances corresponding to the multiple pieces of source domain data to obtain a risk extrapolation parameter corresponding to the multiple pieces of source domain data; and
the determining module is further configured to determine, according to the risk extrapolation parameter and the covariances corresponding to the multiple pieces of source domain data, the health task loss for the multiple pieces of source domain data.

Optionally, the processing module is further configured to determine, using the following formula, the similarity loss for the multiple pieces of source domain data:

$${ℒ}_{similarity} = - log {\sum }_{i} [ \frac{{\sum }_{k \neq i} exp ( - τ \vert {y}_{i} - {y}_{k} \vert ) ‖ {H}_{i}^{{S}^{T}} {H}_{k}^{S} ‖}{{\sum }_{j \neq i} exp ( - τ \vert {y}_{i} - {y}_{j} \vert )} + ε ]$$

where [symbol] _{similarity} is the similarity loss for the multiple pieces of source domain data, yᵢ is an actual health indicator of the multiple pieces of source domain data corresponding to the i-th source domain data, yⱼ is an actual health indicator of the multiple pieces of source domain data corresponding to the j-th source domain data, yₖ is an actual health indicator of the multiple pieces of source domain data corresponding to the k-th source domain data,

$${H}_{i}^{S}$$

is used for indicating a shared feature of the multiple pieces of source domain data corresponding to the i-th source domain data,

$${H}_{k}^{S}$$

is used for indicating a shared feature of the multiple pieces of source domain data corresponding to the k-th source domain data, and τ and ε are hyperparameters determined through experiment.

Optionally, the input module is further configured to input the multiple pieces of source domain data into a private feature extractor to obtain a private feature corresponding to each piece of source domain data;
the input module is further configured to input multiple private features and the multiple shared features into a generator to obtain reconstructed data corresponding to the multiple pieces of source domain data; and
the determining module is further configured to determine, according to the reconstructed data and the multiple pieces of source domain data, a reconstruction loss for the multiple pieces of source domain data;
where the processing module being further configured to perform, according to the multiple pieces of source domain data, based on the health task loss and the similarity loss, update and iteration processing on the shared feature extractor and the shared predictor to obtain the target feature extractor and the target predictor, includes:
performing, according to the multiple pieces of source domain data, based on the health task loss, the similarity loss and the reconstruction loss, update and iteration processing on the shared feature extractor and the shared predictor to obtain the target feature extractor and the target predictor.

Optionally, the processing module is further configured to determine, using the following equation, the reconstruction loss for the multiple pieces of source domain data:

$${ℒ}_{reconstruct} = {\sum }_{k = 1}^{K} \frac{1}{m} {‖ {X}_{k} - {\hat{X}}_{k} ‖}_{2}^{2} + \frac{1}{{m}^{2}} {( ( {X}_{k} - {\hat{X}}_{k} ) \cdot {1}_{m} )}^{2}$$

where [symbol] _{reconstruct} where is the reconstruction loss for the multiple pieces of source domain data, K is a number of source domains of the multiple pieces of source domain data, m is a sequence length of each piece of source domain data, lₘ is a column vector with a length of m and all elements being 1, Xₖ is actual data of the multiple pieces of source domain data corresponding to the k-th source domain, and \hat{X}ₖ is reconstructed data of the multiple pieces of source domain data corresponding to the k-th source domain.

Optionally, the processing module is further configured to perform diversity processing on the multiple private features and the multiple shared features to obtain a diversity loss corresponding to the multiple pieces of source domain data; and
the processing module being further configured to perform, according to the multiple pieces of source domain data, based on the health task loss and the similarity loss, update and iteration processing on the shared feature extractor and the shared predictor to obtain the target feature extractor and the target predictor includes:
performing, according to the multiple pieces of source domain data, based on the health task loss, the similarity loss, the reconstruction loss and the diversity loss, update and iteration processing on the shared feature extractor and the shared predictor to obtaining the target feature extractor and the target predictor.

Optionally, the processing module is further configured to perform, using the health task loss, the similarity loss, the reconstruction loss, and the diversity loss, update processing on the shared feature extractor to obtain an updated shared feature extractor;
the processing module is further configured to perform, according to the multiple pieces of source domain data, iterative training on the updated shared feature extractor until iteration is completed, to obtain the target feature extractor;
the processing module is configured to perform, using the health task loss, update processing on the shared predictor to obtain an updated shared predictor; and
the processing module is configured to perform, according to the multiple pieces of source domain data, iterative training on the updated shared predictor until iteration is completed, to obtain the target predictor.

In a third aspect, the present application provides a domain generalization modelling device for industrial equipment health prediction, including: at least one processor and a memory;
where the memory stores computer-executable instructions; and
the at least one processor executes the computer-executable instructions stored in the memory to implement the domain generalization modelling method for industrial equipment health prediction as described in the first aspect and various possible implementations of the first aspect.

In a fourth aspect, an embodiment of the present application provide a readable storage medium having a computer program stored thereon, and when the computer program is executed by a processor, the domain generalization modelling method for industrial equipment health prediction as described in the first aspect and various possible implementations of the first aspect is implemented.

The present application provides a domain generalization modelling method, apparatus, device and medium for industrial equipment health prediction. The method obtains multiple pieces of source domain data to be predicted, inputs the multiple pieces of source domain data into a shared feature extractor to obtain a shared feature corresponding to each piece of source domain data, where industrial environments of the multiple pieces of source domain data are different; inputs multiple shared features into a shared predictor to obtain a predicted health indicator corresponding to each piece of source domain data; determines, according to multiple predicted health indicators, a health task loss for the multiple pieces of source domain data; performs similarity processing on the multiple shared features to obtain a similarity loss for the multiple pieces of source domain data; performs, according to the multiple pieces of source domain data, based on the health task loss and the similarity loss, update and iteration processing on the shared feature extractor and the shared predictor to obtain a target feature extractor and a target predictor, and constructs a health prediction model based on the target feature extractor and the target predictor. The method effectively solves the problems of variable working conditions, inability to be applied to regression tasks, poor effect of domain generalization and low accuracy of the model faced by the industrial equipment health prediction methods in the prior art, the method can be widely applied in different industrial fields, including machinery, aviation, automotive and other fields, and the method can adaptively deal with the problem of missing features in the industrial time-series data and automatically construct a convolutional neural network for time series analysis.

### BRIEF DESCRIPTION OF DRAWINGS

The accompanying drawings here, which are incorporated into and form a part of the specification, illustrate embodiments consistent with the present application and are used in conjunction with the specification to explain the principles of the present application.

FIG. 1 is a schematic diagram of a framework of a domain generalization modelling method for industrial equipment health prediction provided by the present application;

FIG. 2 is a first flowchart of a domain generalization modelling method for industrial equipment health prediction provided by the present application;

FIG. 3 is a second flowchart of a domain generalization modelling method for industrial equipment health prediction provided by the present application;

FIG. 4 is a third flowchart of a domain generalization modelling method for industrial equipment health prediction provided by the present application;

FIG. 5 is a schematic structural diagram of a domain generalization modelling apparatus for industrial equipment health prediction provided by the present application;

FIG. 6 is a schematic structural diagram of a domain generalization modelling apparatus for industrial equipment health prediction provided by the present application.

By means of the foregoing accompanying drawings, specific embodiments of the present application have been shown, which will be described in more detail in the following. These accompanying drawings and textual descriptions are not intended to limit the scope of the ideas of the present application idea in any way, but rather to illustrate the concepts of the present application for those skilled in the art by reference to particular embodiments.

### DESCRIPTION OF EMBODIMENTS

In order to make the purpose, technical solutions and advantages of the present application clearer, the technical solutions in the present application will be described clearly and completely in the following in conjunction with the accompanying drawings in the present application. It is obvious that the described embodiments are a part of the embodiments in the present application and not all of the embodiments. Based on the embodiments in this application, all other embodiments obtained by a person of ordinary skill in the art without making creative labor fall within the scope of protection of the present application.

The terms “first”, “second”, “third”, “fourth” and the like (if any) in the specification and claims of the present application and the accompanying drawings described above are used to distinguish similar objects and are not necessarily to be used to describe a particular order or sequence. It should be understood that the data used in this way may be interchanged where appropriate, so that the embodiments of the present application described here can be implemented, for example, in an order other than those illustrated or described here.

The words “exemplary” or “for example” are used in the embodiments of this application to denote examples, illustrations, or descriptions. Any embodiment or design solution described as “exemplary” or “for example” in this application should not be construed as being preferred or advantageous over other embodiments or design solutions. Rather, the use of the words “exemplary” or “for example” is intended to present the relevant concepts in a specific manner.

It should be noted that the user information (including, but not limited to, user device information, user personal information, etc.) and data (including, but not limited to, data used for analysis, data stored, data displayed, etc.) involved in the present application are all information and data authorized by the user or sufficiently authorized by all parties, and the collection, use and processing of the relevant data need to comply with relevant laws, regulations and standards of the relevant countries and regions, and corresponding operation portals for users to choose to authorize or reject are provided.

The terms involved in this application are first explained:

Multi-source domain-separation network: multi-source domain-separation network (abbreviated as MS-DSN) is used for cross-domain modelling of industrial equipment health prediction. A domain private component and a domain shared component are applied to obtain domain invariant information from multiple source domain data. MS-DSN utilizes parallel (side-by-side) domain private encoders and a domain shared encoder to explicitly represent domain private information and domain shared information. Domain invariant information relevant to the health prediction task is obtained by filtering domain specific information by maximizing the difference between the domain shared representation and the domain private representation.

Domain Private Encoder: a Domain Private Encoder is a component used in some specific network architectures, especially those models involving multiple data sources or domains (e.g., transfer learning or domain adaptation), of which the main purpose is to extract from a specific data domain (or source) feature information that is specific to that domain and is not shared with other domains.

Domain Shared Encoder: a Domain Shared Encoder is a component that extracts shared features between different data domains when dealing with tasks involving multiple data sources or domains. A Domain Shared Encoder plays a key role in scenarios such as transfer learning, domain adaptation, and multi-source data fusion, etc, of which the main purpose is to learn common representations between multiple data domains that can be shared across different data domains, thus helping the model to transfer and generalize knowledge across different domains.

In practice, a Domain Shared Encoder is often used together with a Domain Private Encoder to learn shared features and private features at the same time. This combination helps the model to make full use of the shared information between different data domains while taking into account the specificity of each data domain. With the Domain Shared Encoder, the model can better adapt to new data domains, improve the performance of cross-domain tasks, and achieve better generalization capabilities in real-world applications.

Domain Private Decoder: a Domain Private Decoder is usually used together with a Domain Shared Encoder, especially in tasks involving multi-source data or multi-domain data, such as transfer learning, domain adaptation or joint learning. Its main role is to decode private features of specific domains from the output of the Domain Private Encoder in order to further exploit or analyze these features. In these tasks, the data usually comes from different domains or distributions, and each domain may contain some unique information that is not shared with other domains.

Supervised Contrastive Learning: Supervised Contrastive Learning is a method used in deep learning to improve features quality. Unlike traditional self-supervised contrastive learning, Supervised Contrastive Learning uses known label information to construct positive sample pairs and negative sample pairs during training. The main purpose of this method is to learn a data representation by comparing the distances between sample pairs, so that samples of the same class are closer together in the feature space and samples of different classes are further away. In Supervised Contrastive Learning, a sample and multiple samples of the same class corresponding to its label are considered as positive sample pairs, while samples of different classes are considered as negative samples. This approach makes full use of the label information and allows the model to learn more accurate and meaningful feature representations.

V-REx method: the V-REx (Value-aware Risk Estimation) method proposed by Krueger et al. is an exploration strategy that combines risk-sensitive exploration and estimation of the value function to balance exploration and exploitation. The V-REx method aims to address common exploration-exploitation trade-offs, especially in the face of sparse rewards or high-dimensional state space. In the V-REx method, risk is measured by estimating the uncertainty of action value, and Krueger et al. propose using an additional risk function to assess the risk of different actions and incorporating the risk estimation into strategy selection. The core idea of the V-REx method is to combine risk estimation with the learning of the value function. The intelligence collects data by interacting with the environment and uses the data to update the estimation of the value function.

Currently, industrial time series prediction, as an important part of industrial intelligence, has received widespread attention since its inception. In order to realize industrial intelligence, it is crucial to properly apply novel AI-based industrial time series prediction techniques. However, most of the industrial equipment health prediction methods face the following unsolved problems. The working conditions of industrial equipment are usually variable, which leads to the assumption of independent identical distribution of monitoring data not being valid, and due to the unknown working conditions, it is difficult to obtain data under the corresponding working conditions to train or fine-tune the model. Although there have been many relatively mature domain generalization methods, most of these methods are for the classification task, and very few are developed for the regression prediction task, and therefore, hence, most of the transfer learning methods cannot be applied to regression tasks. Domain generalization models may be sensitive to the extremely distributed samples, and such extreme samples will reduce the effect of domain generalization and the accuracy of the model.

For the above mentioned problems to be solved faced by most of the industrial equipment health prediction methods, relevant solutions are scarce in the prior art.

In response to the above problems, the present application provides a domain generalization modelling method for industrial equipment health prediction. Multiple pieces of source domain data to be predicted of different industrial environments are obtained, and a shared feature corresponding to each piece of source domain data in the multiple pieces of source domain data is extracted by a shared feature extractor, and the extracted shared feature is inputted into a shared predictor to obtain a corresponding predicted health indicator, and then, a health task loss for the multiple pieces of source domain data to be predicted is determined based on predicted health indicators; at the same time, through performing similarity processing on the extracted shared features, a corresponding similarity loss is obtained, and finally update and iteration processing is performed on the shared feature extractor and the shared predictor based on the health task loss and the similarity loss to obtain a qualified target feature extractor and a qualified target predictor and the construction of a health prediction model is completed. The method effectively solves the problems of variable working conditions, inability to be applied to regression tasks, poor effect of domain generalization and low accuracy of the model faced by the industrial equipment health prediction methods in the prior art, the method can be widely applied in different industrial fields, including machinery, aviation, automotive and other fields, and the method can adaptively deal with the problem of missing features in the industrial time-series data and automatically constructs a convolutional neural network for time series analysis.

The technical solution of the present application and how the technical solution of the present application solves the above technical problems are described in detail in the following specific embodiments. The following specific embodiments may be combined with each other, and the same or similar concepts or processes may not be repeated in some embodiments. Embodiments of the present application will be described below in conjunction with the accompanying drawings.

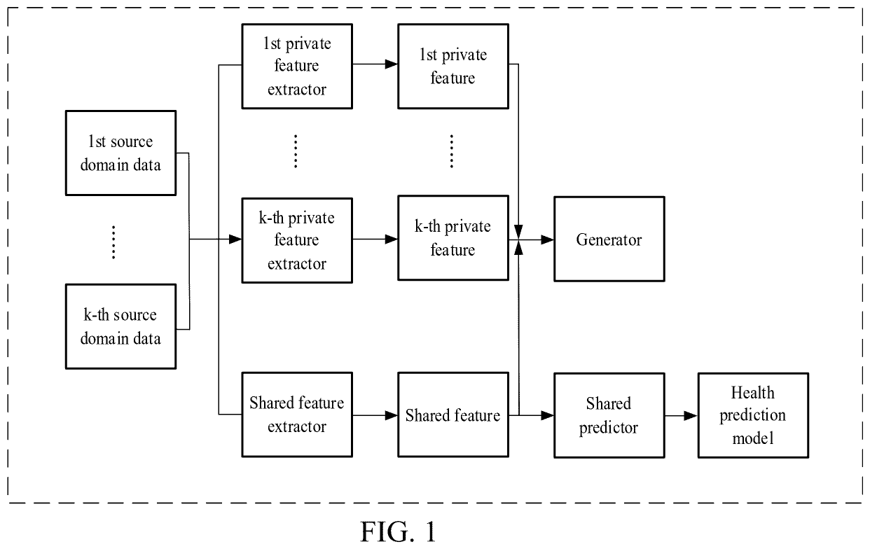

FIG. 1 is a schematic diagram of a framework for a domain generalization modelling method for industrial equipment health prediction provided by an embodiment of the present application. As shown in FIG. 1, the framework includes: k pieces of source domain data, k private feature extractors, a shared feature extractor, a generator for restoring a feature, and a shared predictor, where k is an integer ≥1, which can be set according to the actual application scenario. Through inputting the k pieces of source domain data into the k private feature extractors and the shared predictor, a private feature and a shared feature corresponding to each piece of source domain data are extracted. Then the extracted private feature and the extracted shared feature are inputted into the generator to obtain restored data corresponding to each source domain. From the restored data corresponding to each source domain and the k pieces of source domain data, the reconstruction loss for the k pieces of source domain data can be determined. At the same time, shared features are inputted into the shared predictor to obtain a predicted health indicator corresponding to each piece of source domain data. A health task loss, a similarity loss, and a diversity loss corresponding to the k pieces of source domain data are determined according to the k pieces of source domain data and based on the predicted health indicators, an actual health indicator corresponding to each piece of source domain data, and the extracted private feature and shared feature corresponding to each piece of source domain data. Finally, by training with the health task loss, the similarity loss, the reconstruction loss and the diversity loss, update and iteration processing on the shared feature extractor and the shared predictor can be completed to obtain the trained health prediction model.

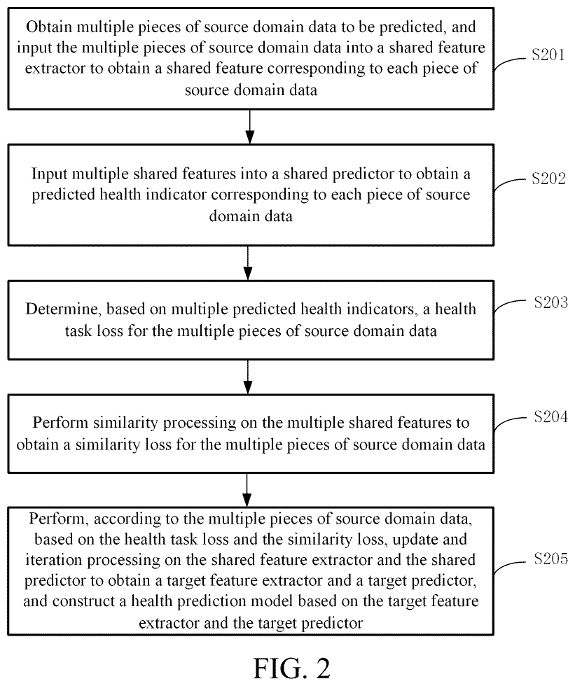

FIG. 2 a first flowchart of a domain generalization modelling method for industrial equipment health prediction provided by an embodiment of the present application. As shown in FIG. 2, the domain generalization modelling method for industrial equipment health prediction illustrated in the embodiment includes:

S201: obtain multiple pieces of source domain data to be predicted, and input the multiple pieces of source domain data into a shared feature extractor to obtain a shared feature corresponding to each piece of source domain data.

The multiple pieces of source domain data to be predicted may include, for example: source domain data for equipment temperature, source domain data for equipment air pressure, and source domain data for equipment workpiece vibration frequency in the industrial equipment. The shared feature extractor is used to extract shared features corresponding to the multiple pieces of source domain data, and the shared feature extractor may be, for example: a domain shared encoder. At the same time, the multiple pieces of source domain data to be predicted are inputted to the private feature extractors to extract the private feature corresponding to each piece of source domain data to complete the subsequent construction of the health prediction model. The shared features and the private features corresponding to the multiple pieces of source domain data may be, for example, projected into a shared space and a private space, respectively, to facilitate subsequent extraction of the shared feature.

It may be understood that the multiple pieces of source domain data may, for example, correspond to multiple shared features due to different industrial environments of the multiple pieces of source domain data.

S202: Input multiple shared features into a shared predictor to obtain a predicted health indicator corresponding to each piece of source domain data.

The shared predictor may, for example, predict a predicted health indicator of corresponding equipment based on the multiple shared features, and the predicted health indicator may be, for example: a prediction of a service life corresponding to the equipment and a health indicator related to the usage performance of the equipment.

S203: determine, according to multiple predicted health indicators, a health task loss for the multiple pieces of source domain data.

The health task loss may be determined, for example, according to the actual health indicators and the predicted health indicators corresponding to the multiple pieces of source domain data. The health task loss may be determined, for example, based on the V-REx method, and the determination process may be, for example: first, a prediction bias and a covariance corresponding to each piece of source domain data are determined according to the multiple predicted health indicators and the multiple actual health indicators, and variance solving processing is then performed on prediction biases and covariances to obtain a risk extrapolation parameter corresponding to the multiple pieces of source domain data, and finally, the health task loss for the multiple pieces of source domain data can be determined according to the risk extrapolation parameter and the covariances corresponding to the multiple pieces of source domain data.

S204: perform similarity processing on the multiple shared features to obtain a similarity loss for the multiple pieces of source domain data.

The similarity processing may be, for example: based on the Supervised Contrastive Learning method, making the shared features that are extracted from the multiple pieces of source domain data as similar as possible without loss of generality, thereby achieving a higher degree of similarity of the shared features.

The process of similarity processing based on the supervised contrastive learning method may, for example, include: first, performing paradigm solving processing on the multiple shared features, then performing index solving processing on the actual health indicators corresponding to the multiple pieces of source domain data to obtain corresponding similarity parameters, and finally, determining a corresponding similarity loss from the similarity parameters.

S205: perform, according to the multiple pieces of source domain data, based on the health task loss and the similarity loss, update and iteration processing on the shared feature extractor and the shared predictor to obtain a target feature extractor and a target predictor, and construct a health prediction model according to the target feature extractor and the target predictor.

The update and iteration processing may be, for example: within a target number of iterations, updating the shared feature extractor and the shared predictor by constant training with the health task loss and the similarity loss, so as to make the prediction results obtained by the shared feature extractor and the shared predictor more ideal, and thus constructing a more accurate health prediction model according to the shared feature extractor and the shared predictor under the ideal situation. The target number of iterations may be, for example set manually, or iteration may be completed when the result of the next iteration is worse than the result of the previous iteration, which is not specifically limited here and may depend on the actual situation.

The present embodiment provides a domain generalization modelling method for industrial equipment health prediction. Multiple pieces of source domain data to be predicted are obtained, and a shared feature corresponding to each piece of source domain data of the multiple pieces of source domain data is obtained by a shared feature extractor, the extracted shared feature is inputted into a shared predictor to obtain a corresponding predicted health indicator, and then a health task loss for the multiple pieces of source domain data is determined according to predicted health indicators; at the same time, a corresponding similarity loss is obtained through performing similarity processing on the extracted shared features, and finally update and iteration processing is performed on the shared feature extractor and the shared predictor based on the health task loss and the similarity loss to obtain a qualified target feature extractor and a qualified target predictor and the construction of a health prediction model is completed. The method is based on the multi-source domain-separation network, which effectively solves the problems of variable working conditions, inability to be applied to regression tasks, poor effect of domain generalization and low accuracy of the model faced by the industrial equipment health prediction methods in the prior art.

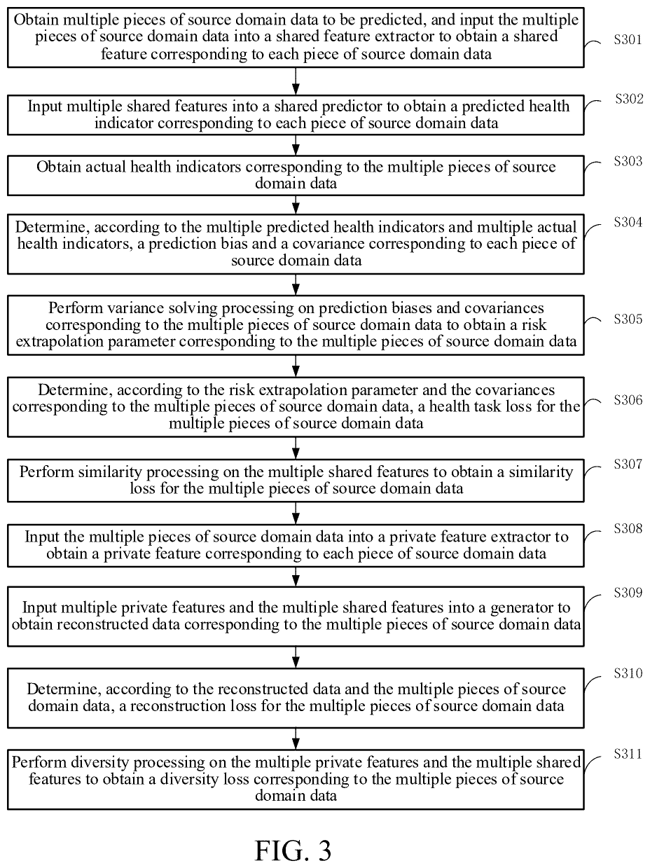

FIG. 3 is a second flowchart of a domain generalization modelling method for industrial equipment health prediction provided by an embodiment of the present application. As shown in FIG. 3, the present embodiment is a detailed description of the domain generalization modelling method for industrial equipment health prediction on the basis of the embodiment of FIG. 2. The domain generalization modelling method for industrial equipment health prediction illustrated in this embodiment includes:

S301: obtain multiple pieces of source domain data to be predicted, and input the multiple pieces of source domain data into a shared feature extractor to obtain a shared feature corresponding to each piece of source domain data.

Step S301 is similar to the step S201 above and is not described here.

S302: input multiple shared features into a shared predictor to obtain a predicted health indicator corresponding to each piece of source domain data.

Step S302 is similar to the step S202 above and is not described here.

S303: obtain actual health indicators corresponding to the multiple pieces of source domain data.

The actual health indicators corresponding to the multiple pieces of source domain data may be, for example the service life corresponding to equipment and a health indicator related to the usage performance of equipment.

It may be understood that the actual health indicator is fixed in the ideal situation, but since the actual health indicators correspond to different industrial environments, the actual health indicators may change accordingly, and accurate prediction of the actual health indicator may provide great convenience for the use of industrial equipment.

S304: determine, according to the multiple predicted health indicators and multiple actual health indicators, a prediction bias and a covariance corresponding to each piece of source domain data.

The prediction bias may be, for example, a prediction bias generated based on the V-REx method.

S305: perform variance solving processing on prediction biases and covariances corresponding to the multiple pieces of source domain data to obtain a risk extrapolation parameter corresponding to the multiple pieces of source domain data.

The risk extrapolation parameter may be, for example, a parameter corresponding to a risk extrapolation function.

S306: determine, according to the risk extrapolation parameter and the covariances corresponding to the multiple pieces of source domain data, a health task loss for the multiple pieces of source domain data.

For example, the health task loss for the multiple pieces of source domain data may be determined by the following formula:

$${ℛ}_{DREx} \dot{=} Var ( \{ {ℛ}_{1} , … , {ℛ}_{k} \} ) + φ Var ( \{ {ℬ}_{1} , … , {ℬ}_{k} \} ) ,$$

$${ℛ}_{k} = \frac{1}{{N}_{k}} {\sum }_{i = 1}^{{N}_{k}} {( {y}_{i} - {\hat{y}}_{i} )}^{2} ,$$

$${ℬ}_{k} = \frac{1}{{N}_{k}} {\sum }_{i = 1}^{{N}_{k}} ( exp ( {y}_{i} - {\hat{y}}_{i} - ψ ) + exp ( {\hat{y}}_{i} - {y}_{i} - ψ ) ) ,$$

$${ℒ}_{task} = {δℛ}_{DREx} + {\sum }_{k = 1}^{K} {ℛ}_{k}$$

Where [symbol] _{DREx} is a directional risk extrapolation function, K is the number of source domains of the multiple pieces of source domain data, Var is used to indicate performing variance solving on, { [symbol] ₁, . . . , [symbol] _{K}}, { [symbol] ₁, . . . , [symbol] _{K}}, φ is the hyperparameter that makes exp(yᵢ−ŷᵢ−ψ), exp(ŷᵢ−yᵢ−ψ) greater than 1, [symbol] ₁, . . . , [symbol] _{K} are the covariances of the prediction risk corresponding to the multiple pieces of source domain data, respectively, [symbol] ₁, . . . , [symbol] _{K} are the prediction biases corresponding to the multiple pieces of source domain data, yᵢ is the actual health indicator corresponding to the multiple pieces of source domain data, ŷᵢ, is the predicted health indicator corresponding to the multiple pieces of source domain data, [symbol] ₜₐₛₖ is the health task loss corresponding to the multiple pieces of source domain data, Nₖ is a data quantity of the k-th source domain, and δ is a hyperparameter determined through experiment.

S307: perform similarity processing on the multiple shared features to obtain a similarity loss for the multiple pieces of source domain data.

For example, the similarity loss for the multiple pieces of source domain data may be determined by the following formula:

$${ℒ}_{similarity} = - log {\sum }_{i} [ \frac{{\sum }_{k \neq i} exp ( - τ \vert {y}_{i} - {y}_{k} \vert ) ‖ {H}_{i}^{{S}^{T}} {H}_{k}^{S} ‖}{{\sum }_{j \neq i} exp ( - τ \vert {y}_{i} - {y}_{j} \vert )} + ε ]$$

where [symbol] _{similarity} is the similarity loss for the multiple pieces of source domain data, yᵢ an actual health indicator of the multiple pieces of source domain data corresponding to the i-th source domain data, yⱼ is an actual health indicator of the multiple pieces of source domain data corresponding to the j-th source domain data, yₖ is an actual health indicator of the multiple pieces of source domain data corresponding to the k-th source domain data,

$${H}_{í}^{S}$$

is used for indicating a shared feature of the multiple pieces of source domain data corresponding to the i-th source domain data, Hₖ^{S} is used for indicating a shared feature of the multiple pieces of source domain data corresponding to the k-th source domain data, and τ and ε are hyperparameters determined through experiment.

S308: input the multiple pieces of source domain data into a private feature extractor to obtain a private feature corresponding to each piece of source domain data.

The private feature extractor is used to extract the private features corresponding to the multiple pieces of source domain data, and the private feature extractor may be, for example: a domain private encoder.

It may be understood that the multiple pieces of source domain data may, for example, correspond to multiple private features due to different industrial environments of the multiple pieces of source domain data.

S309: input multiple private features and the multiple shared features into a generator to obtain reconstructed data corresponding to the multiple pieces of source domain data.

The generator is used to restore the multiple pieces of source domain data corresponding to the multiple private features and the multiple shared features to obtain the reconstructed data of the multiple pieces of source domain data.

It may be understood that the purpose of the step is to perform reconstruction loss processing according to the reconstructed data and the original multiple pieces of source domain data, so as to reduce the prediction error of the system by reducing the reconstruction loss corresponding to the multiple pieces of source domain data, thereby making the health prediction results of the health prediction model for industrial equipment more accurate.

S310: determine, according to the reconstructed data and the multiple pieces of source domain data, a reconstruction loss for the multiple pieces of source domain data.

For example, the reconstruction loss for the multiple pieces of source domain data may be determined by the following formula:

$${ℒ}_{reconstruct} = {\sum }_{k = 1}^{K} \frac{1}{m} {‖ {X}_{k} - {\hat{X}}_{k} ‖}_{2}^{2} + \frac{1}{{m}^{2}} {( ( {X}_{k} - {\hat{X}}_{k} ) \cdot {1}_{m} )}^{2}$$

where [symbol] _{reconstruct} is the reconstruction loss for the multiple pieces of source domain data, K is a number of source domains of the multiple pieces of source domain data, m is a sequence length of each piece of source domain data, lₘ is a column vector with a length of m and all elements being 1, Xₖ is actual data of the multiple pieces of source domain data corresponding to the k-th source domain, and \hat{X}ₖ is reconstructed data of the multiple pieces of source domain data corresponding to the k-th source domain.

S311: perform diversity processing on the multiple private features and the multiple shared features to obtain a diversity loss corresponding to the multiple pieces of source domain data.

The diversity processing may be, for example, filtering out private feature information in the shared features and filtering out shared feature information in the private features, so as to make the extracted shared features and the extracted private features more accurate, thereby further improving the accuracy of the prediction results of the health prediction model.

For example, the following formula can be used to obtain the diversity loss:

$${ℒ}_{diversity} = {\sum }_{k = 1}^{K} {‖ {H}_{k}^{{P}^{T}} {H}_{k}^{S} ‖}_{F}^{2}$$

where [symbol] _{diversity} is the diversity loss, K is the number of source domains of the multiple pieces of source domain data,

$${H}_{k}^{P}$$

is used for indicating a private feature of the multiple pieces of source domain data corresponding to the k-th source domain data,

$${H}_{k}^{S}$$

is used for indicating a shared feature of the multiple pieces of source domain data corresponding to the k-th source domain data.

It is worth mentioning that the processing order of the above health task loss, similarity loss, reconstruction loss, and diversity loss may be simultaneous without affecting each other or flexibly adjusted according to the actual situation, and no specific restriction is made here.

The present embodiment provides a domain generalization modelling method for industrial equipment health prediction, which introduces determining the health task loss corresponding to the multiple pieces of source domain data according to the risk extrapolation parameter and the covariances corresponding to the multiple pieces of source domain data, determining the similarity loss corresponding to the multiple pieces of source domain data according to the similarity parameters, determining the reconstruction loss corresponding to the multiple pieces of source domain data according to the reconstructed data, and determining the diversity loss corresponding to the multiple pieces of source domain data by performing diversity processing on the extracted multiple private features and multiple shared features.

The method is based on the multi-source domain-separation network, and through the continuous training processing with the health task loss, the similarity loss, the reconstruction loss and the diversity loss, the method greatly reduces the prediction error of the health prediction model, and solves the problems of variable working conditions, inapplicable to regression tasks, poor effect of domain generalization and low accuracy of the model faced by the industrial equipment health prediction methods in the prior art, and the method introduces a private subspace and a shared subspace for each piece of source domain data, and captures domain invariant shared features by excluding private features, and the method realizes high generalization modelling of industrial time series prediction under variable and unknown working conditions, achieves domain generalization modelling for the prediction task, avoids the impact of extreme distribution changes on domain generalization modelling, effectively reduces the sensitivity of the prediction model to extreme distribution changes, and improves overall robustness of the model to distribution changes.

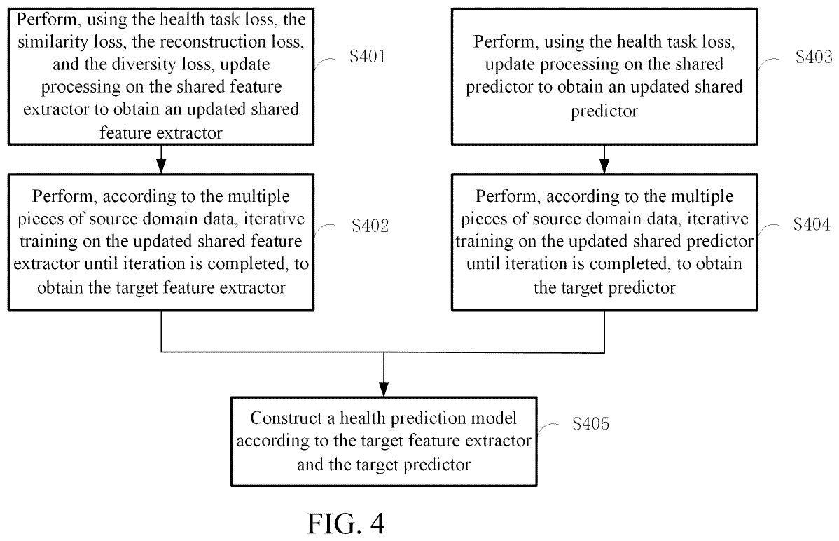

FIG. 4 is a third flow chart of a domain generalization modelling method for industrial equipment health prediction provided by an embodiment of the present application. As shown in FIG. 4, the embodiment is based on the embodiment of FIG. 1 or FIG. 2, and provides a detailed description of how to construct a health prediction model after obtaining the diversity loss, the health task loss, the similarity loss, and the reconstruction loss corresponding to the multiple pieces of source domain data. The present embodiment illustrates a domain generalization modelling method for industrial equipment health prediction, including:

S401: perform, using the health task loss, the similarity loss, the reconstruction loss, and the diversity loss, update processing on the shared feature extractor to obtain an updated shared feature extractor.

For example, the update processing on the shared feature extractor may be performed by the following formula:

$${ℒ}_{{E}^{S}} = {ℒ}_{task} + {αℒ}_{reconstruct} + {βℒ}_{diversity} + {γℒ}_{similarity}$$

where α, β, γ are hyperparameters of interactions between the loss terms, [symbol] ₜₐₛₖ is used for indicating the health task loss, [symbol] _{reconstruct} is used for indicating the reconstruction loss, [symbol] _{diversity} is used for indicating the diversity loss, [symbol] _{similarity} is used for indicating the similarity loss, and [symbol] _{E}s is used for indicating the shared feature extractor parameter.

The updating process of the shared feature extractor may be, for example, as follows: sampling a small batch of multiple pieces of source domain data, and when collaboratively adjusting the health task loss, the similarity loss, the reconstruction loss, and the diversity loss corresponding to the small batch of multiple pieces of source domain data, performing the update processing on the shared feature extractor for each collaborative adjustment and completing the update when the health task loss, the similarity loss, the reconstruction loss, and the diversity loss achieve an ideal adjustment effect, where the ideal adjustment effect may be, for example, a situation where the health task loss, the similarity loss, the reconstruction loss, and the diversity loss are all as small as possible.

S402: perform, according to the multiple pieces of source domain data, iterative training on the updated shared feature extractor until iteration is completed, to obtain the target feature extractor.

The multiple pieces of source domain data may be, for example, divided into multiple batches to perform iterative training on the updated shared feature extractor, where the multiple pieces of source domain data may be, for example, multiple pieces of source domain data covering as wide a range as possible. When an iteration completion condition is reached, the shared feature extractor is accordingly in a more ideal state, and the iteration completion condition may be, for example set manually, or may be that the iteration is completed when the result of the next iteration is worse than the result of the previous iteration.

S403: perform, using the health task loss, update processing on the shared predictor to obtain an updated shared predictor.

Performing update processing on the shared predictor may be, for example, performing update processing when the health task loss is decreasing. Meanwhile, since the health task loss is obtained based on the shared features, the shared predictor trained on the basis of the shared features can better perform domain generalization processing on different source domain data, thereby achieving the effect of source domain data generalization and further improving the prediction result of the health prediction model.

S404: perform, based on the multiple pieces of source domain data, iterative training on the updated shared predictor until iteration is completed, to obtain the target predictor.

The multiple pieces of source domain data may be, for example, divided into multiple batches to perform iterative training on the updated shared predictor, where the multiple pieces of source domain data may be, for example, multiple pieces of source domain data covering as wide a range as possible. When an iteration completion condition is reached, the shared predictor is accordingly in a more ideal state, and the iteration completion condition may be, for example: set manually or may be that the iteration is completed when the result of the next iteration is worse than the result of the previous iteration.

S405: construct a health prediction model based on the target feature extractor and the target predictor.

Optionally, while constructing the health prediction model based on the target feature extractor and the target predictor, for example, the update processing of the private feature extractor may also be completed according to the reconstruction loss and the diversity loss, the update processing of the generator can be completed according to the reconstruction loss, and the updated private feature extractor and generator can be applied to the above updating and iterative training process of the shared feature extractor and the shared predictor to construct the health prediction model, thereby further improving the accuracy of the prediction results of the health prediction model.

The present embodiment provides a domain generalization modelling method for industrial equipment health prediction, which introduces performing iterative training on the shared feature extractor and shared predictor based on the diversity loss, the health task loss, the similarity loss and the reconstruction loss to obtain the target predictor and the target feature extractor, and the construction of the health prediction model can be completed based on the target predictor and the target feature extractor. The method, by utilizing the diversity loss, the health task loss, the similarity loss, and the reconstruction loss to complete the iterative training of the target predictor and the target feature extractor, greatly improves the accuracy of the health prediction model, and effectively solves the problems of variable working conditions, inapplicability to regression tasks, poor effect of domain generalization and low accuracy of the model faced by the industrial equipment health prediction methods in the prior art.

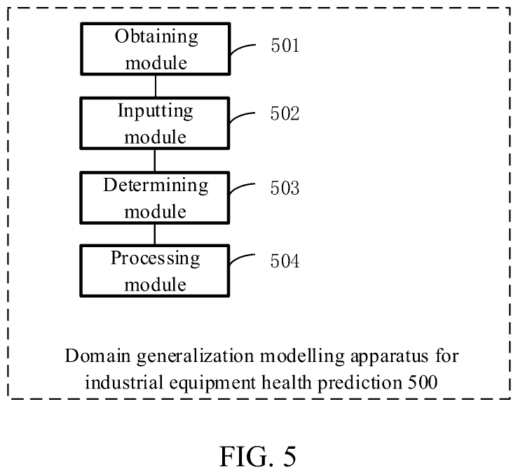

FIG. 5 is a schematic structural diagram of a domain generalization modelling apparatus for industrial equipment health prediction provided by an embodiment of the present application. As shown in FIG. 5, the domain generalization modelling apparatus for industrial equipment health prediction 500 provided by the present application includes:
an obtaining module 501, configured to obtain multiple pieces of source domain data to be predicted, and input the multiple pieces of source domain data into a shared feature extractor to obtain a shared feature corresponding to each piece of source domain data, where industrial environments of the multiple pieces of source are different;
an input module 502, configured to input multiple shared features into a shared predictor to obtain a predicted health indicator corresponding to each piece of source domain data;
a determining module 503, configured to determine, according to multiple predicted health indicators, a health task loss for the multiple pieces of source domain data; and
a processing module 504, configured to perform similarity processing on the multiple shared features to obtain a similarity loss for the multiple pieces of source domain data;
where the processing module 504 is further configured to perform, according to the multiple pieces of source domain data, based on the health task loss and the similarity loss, update and iteration processing on the shared feature extractor and the shared predictor to obtain a target feature extractor and a target predictor, and construct a health prediction model based on the target feature extractor and the target predictor.

Optionally, the obtaining module 501 is further configured to obtain actual health indicators corresponding to the multiple pieces of source domain data;
the determining module 503 is further configured to determine, according to the multiple predicted health indicators and multiple actual health indicators, a prediction bias and a covariance corresponding to each piece of source domain data;
the processing module 504 is further configured to perform variance solving processing on prediction biases and covariances corresponding to the multiple pieces of source domain data to obtain a risk extrapolation parameter corresponding to the multiple pieces of source domain data; and
the determining module 503 is further configured to determine, according to the risk extrapolation parameter and the covariances corresponding to the multiple pieces of source domain data, a health task loss for the multiple pieces of source domain data.

Optionally, the processing module 504 is further configured to determine, using the following formula, the similarity loss for the multiple pieces of source domain data:

$${ℒ}_{similarity} = - log {\sum }_{i} [ \frac{{\sum }_{k \neq i} exp ( - τ \vert {y}_{i} - {y}_{k} \vert ) ‖ {H}_{i}^{{S}^{T}} {H}_{k}^{S} ‖}{{\sum }_{j \neq i} exp ( - τ \vert {y}_{i} - {y}_{j} \vert )} + ε ]$$

where [symbol] _{similarity} is the similarity loss for the multiple pieces of source domain data, yᵢ is an actual health indicator of the multiple pieces of source domain data corresponding to the i-th source domain data, yⱼ is an actual health indicator of the multiple pieces of source domain data corresponding to the j-th source domain data, yₖ is an actual health indicator of the multiple pieces of source domain data corresponding to the k-th source domain data,

$${H}_{i}^{S}$$

is used for indicating a shared feature of the multiple pieces of source domain data corresponding to the i-th source domain data,

$${H}_{k}^{S}$$

is used for indicating a shared feature of the multiple pieces of source domain data corresponding to the k-th source domain data, and τ and ε are hyperparameters determined through experiment.

Optionally, the input module 502 is further configured to input the multiple pieces of source domain data into a private feature extractor to obtain a private feature corresponding to each piece of source domain data;
the input module 502 is further configured to input multiple private features and the multiple shared features into a generator to obtain reconstructed data corresponding to the multiple pieces of source domain data; and
the determining module 503 is further configured to determine, according to the reconstructed data and the multiple pieces of source domain data, a reconstruction loss for the multiple pieces of source domain data;
the processing module 504 is further configured to perform, according to the multiple pieces of source domain data, based on the health task loss, the similarity loss and the reconstruction loss, update and iteration processing on the shared feature extractor and the shared predictor to obtain the target feature extractor and the target predictor.

Optionally, the processing module 504 is further configured to determine, using the following equation, the reconstruction loss for the multiple pieces of source domain data:

$${ℒ}_{reconstruct} = {\sum }_{k = 1}^{K} \frac{1}{m} {‖ {X}_{k} - {\hat{X}}_{k} ‖}_{2}^{2} + \frac{1}{{m}^{2}} {( ( {X}_{k} - {\hat{X}}_{k} ) \cdot {1}_{m} )}^{2}$$

where [symbol] _{reconstruct} is the reconstruction loss for the multiple pieces of source domain data, K is a number of source domains of the multiple pieces of source domain data, m is a sequence length of each piece of source domain data, lₘ is a column vector with a length of m and all elements being 1, Xₖ is actual data of the multiple pieces of source domain data corresponding to the k-th source domain, and \hat{X}ₖ is reconstructed data of the multiple pieces of source domain data corresponding to the k-th source domain.

Optionally, the processing module 504 is further configured to perform diversity processing on the multiple private features and the multiple shared features to obtain a diversity loss corresponding to the multiple pieces of source domain data; and
the processing module 504 is further configured to perform, according to the multiple pieces of source domain data, based on the health task loss, the similarity loss, the reconstruction loss and the difference loss, updating and iteration processing on the shared feature extractor and the shared predictor to obtain the target feature extractor and the target predictor.

Optionally, the processing module 504 is further configured to perform, using the health task loss, the similarity loss, the reconstruction loss and the diversity loss, update processing on the shared feature extractor to obtain an updated shared feature extractor;
the processing module 504 is further configured to perform, according to the multiple pieces of source domain data, iterative training on the updated shared feature extractor until iteration is completed, to obtain the target feature extractor;
the processing module 504 is, further configured to perform, using the health task loss, update processing on the shared predictor to obtain an updated shared predictor; and
the processing module 504 is further configured to perform, according to the multiple pieces of source domain data, iterative training on the updated shared predictor until iteration is completed, to obtain the target predictor.

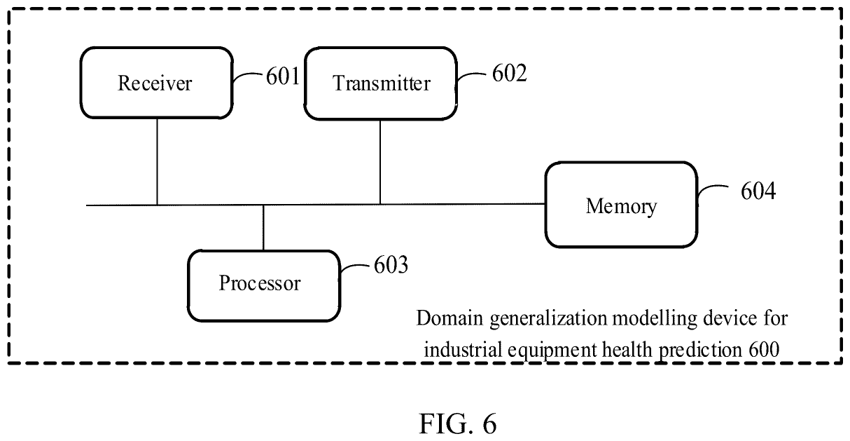

FIG. 6 is a schematic structural diagram of a domain generalization modelling device for industrial equipment health prediction provided by the present application. As shown in FIG. 6, the present application provides a domain generalization modelling device for industrial equipment health prediction, and the domain generalization modelling device for industrial apparatus health prediction 600 includes: a receiver 601, a transmitter 602, a processor 603, and a memory 604.

The receiver 601 is configured to receive instructions and data;
the transmitter 602 is configured to send instructions and data;
the memory 604 is configured to store computer-executable instructions; and
the processor 603 is configured to execute the computer-executable instructions stored in the memory 604 to implement the various steps performed by the domain generalization modelling method for industrial equipment health prediction in the above embodiments. Specifically, reference may be made to the relevant description in the aforementioned embodiments of the domain generalization modelling method for industrial equipment health prediction.

Optionally, the aforementioned memory 604 may be either stand-alone or integrated with the processor 603.

When the memory 604 is stand-alone, the electronic device further includes a bus for connecting the memory 604 to the processor 603.

The present application also provides a computer-readable storage medium, where the computer-readable storage medium stores computer-executable instructions, and when the processor executes the computer-executable instructions, the domain generalization modelling method for industrial equipment health prediction performed by the aforementioned domain generalization modelling device for industrial apparatus health prediction is implemented.

It may be understood by a person with ordinary skill in the art that all or some of the steps, systems, and functional modules/units in the method disclosed above may be implemented as software, firmware, hardware, and suitable combinations thereof. In hardware implementations, the classification between functional modules/units referred to in the above description does not necessarily correspond to a classification of physical components; for example, a physical component may have more than one functions, or a function or step may be cooperatively performed by a number of physical components. Some or all of the physical components may be implemented as software executed by a processor, such as a central processor, a digital signal processor, or a microprocessor, or as hardware, or as an integrated circuit, such as an application-specific integrated circuit. Such software may be distributed on a computer-readable medium, which may include a computer storage medium (or non-transitory medium) and a communication medium (or transitory medium). As is well known to those of ordinary skill in the art, the term, computer storage medium, includes volatile and non-volatile, removable and non-removable media implemented in any method or technique for storing information, such as computer-readable instructions, data structures, program modules or other data. Computer storage media include, but are not limited to, RAM, ROM, EEPROM, flash memory or other memory technology, CD-ROM, digital versatile disk (DVD) or other optical disc storage, magnetic cartridges, magnetic tapes, magnetic disk storage or other magnetic storage devices, or any other media that can be used to store desired information and that can be accessed by a computer. In addition, it is well known to those of ordinary skill in the art that communication media typically contain computer-readable instructions, data structures, program modules, or other data in a modulated data signal such as a carrier wave or other transmission mechanism, and may include any information delivery medium.

Other embodiments of the present application will readily be thought of by those skilled in the art upon consideration of the specification and practice of the application disclosed here. The present application is intended to cover any variations, uses or adaptations of the present application, which follow the general principles of the present application and include common knowledge or conventional technical means in the art not disclosed here. The specification and embodiments are regarded as exemplary only, and the true scope and spirit of the application is indicated by the following claims.

It should be understood that the application is not limited to the precise structure which has been described above and illustrated in the accompanying drawings, and various modifications and changes may be made without departing from the scope thereof. The scope of the application is limited only by the appended claims.

What is claimed is:

1. A domain generalization modelling method for industrial equipment health prediction, wherein the method comprises:
obtaining multiple pieces of source domain data to be predicted, and inputting the multiple pieces of source domain data into a shared feature extractor to obtain a shared feature corresponding to each piece of source domain data, wherein industrial environments of the multiple pieces of source domain data are different;
inputting multiple shared features into a shared predictor to obtain a predicted health indicator corresponding to each piece of source domain data;
determining, according to multiple predicted health indicators, a health task loss for the multiple pieces of source domain data;
performing similarity processing on the multiple shared features to obtain a similarity loss for the multiple pieces of source domain data; and
performing, according to the multiple pieces of source domain data, based on the health task loss and the similarity loss, update and iteration processing on the shared feature extractor and the shared predictor to obtain a target feature extractor and a target predictor, and constructing a health prediction model based on the target feature extractor and the target predictor.

2. The method according to claim 1, wherein the determining, according to the multiple predicted health indicators, the health task loss for the multiple pieces of source domain data comprises:
obtaining actual health indicators corresponding to the multiple pieces of source domain data;
determining, according to the multiple predicted health indicators and multiple actual health indicators, a prediction bias and a covariance corresponding to each piece of source domain data;
performing variance solving processing on prediction biases and covariances corresponding to the multiple pieces of source domain data to obtain a risk extrapolation parameter corresponding to the multiple pieces of source domain data; and
determining, according to the risk extrapolation parameter and the covariances corresponding to the multiple pieces of source domain data, a health task loss for the multiple pieces of source domain data.

3. The method according to claim 2, wherein the performing similarity processing on the multiple shared features to obtain the similarity loss for the multiple pieces of source domain data comprises:
determining, using the following formula, the similarity loss for the multiple pieces of source domain data:
$${ℒ}_{similarity} = - log {\sum }_{i} [ \frac{{\sum }_{k \neq i} - exp ( - τ \vert {y}_{i} - {y}_{k} \vert ) ‖ {H}_{i}^{{S}^{T}} {H}_{k}^{S} ‖}{{\sum }_{j \neq i} exp ( - τ \vert {y}_{i} - {y}_{j} \vert )} + ε ]$$
wherein [symbol] _{similarity} is the similarity loss for the multiple pieces of source domain data, yᵢ is an actual health indicator of the multiple pieces of source domain data corresponding to an i-th source domain data, yⱼ is an actual health indicator of the multiple pieces of source domain data corresponding to a j-th source domain data, yₖ is an actual health indicator of the multiple pieces of source domain data corresponding to a k-th source domain data,
$${H}_{i}^{S}$$
is used for indicating a shared feature of the multiple pieces of source domain data corresponding to an i-th source domain data,
$${H}_{k}^{S}$$
is used for indicating a shared feature of the multiple pieces of source domain data corresponding to a k-th source domain data, and τ and ε are hyperparameters determined through experiment.

4. The method according to claim 1, wherein before performing, according to the multiple pieces of source domain data, based on the health task loss and the similarity loss, update and iteration processing on the shared feature extractor and the shared predictor to obtain the target feature extractor and the target predictor, the method further comprises:
inputting the multiple pieces of source domain data into a private feature extractor to obtain a private feature corresponding to each piece of source domain data;
inputting multiple private features and the multiple shared features into a generator to obtain reconstructed data corresponding to the multiple pieces of source domain data;
determining, according to the reconstructed data and the multiple pieces of source domain data, a reconstruction loss for the multiple pieces of source domain data; and
wherein the performing, according to the multiple pieces of source domain data, based on the health task loss and the similarity loss, update and iteration processing on the shared feature extractor and the shared predictor to obtain the target feature extractor and the target predictor comprises:
performing, according to the multiple pieces of source domain data, based on the health task loss, the similarity loss and the reconstruction loss, update and iteration processing on the shared feature extractor and the shared predictor to obtain the target feature extractor and the target predictor.

5. The method according to claim 4, wherein the determining, according to the reconstructed data and the multiple pieces of source domain data, the reconstruction loss for the multiple pieces of source domain data comprises:
determining, using the following equation, the reconstruction loss for the multiple pieces of source domain data:
$${ℒ}_{reconstruct} = {\sum }_{k = 1}^{K} \frac{1}{m} {‖ {X}_{k} - {\hat{X}}_{k} ‖}_{2}^{2} + \frac{1}{{m}^{2}} {( ( {X}_{k} - {\hat{X}}_{k} ) \cdot {1}_{m} )}^{2}$$
wherein [symbol] _{reconstruct} is the reconstruction loss for the multiple pieces of source domain data, K is a number of source domains of the multiple pieces of source domain data, m is a sequence length of each piece of source domain data, lₘ is a column vector with a length of m and all elements being 1, Xₖ is actual data of the multiple pieces of source domain data corresponding to a k-th source domain, and \hat{X}ₖ is reconstructed data of the multiple pieces of source domain data corresponding to the k-th source domain.

6. The method according to claim 4, wherein before performing, according to the multiple pieces of source domain data, based on the health task loss and the similarity loss, update and iteration processing on the shared feature extractor and the shared predictor to obtain the target feature extractor and the target predictor, the method further comprises:
performing diversity processing on the multiple private features and the multiple shared features to obtain a diversity loss corresponding to the multiple pieces of source domain data; and
wherein the performing, according to the multiple pieces of source domain data, based on the health task loss and the similarity loss, update and iteration processing on the shared feature extractor and the shared predictor to obtain the target feature extractor and the target predictor comprises:
performing, according to the multiple pieces of source domain data, based on the health task loss, the similarity loss, the reconstruction loss and the diversity loss, update and iteration processing on the shared feature extractor and the shared predictor to obtain the target feature extractor and the target predictor.

7. The method according to claim 6, wherein the performing, according to the multiple pieces of source domain data, based on the health task loss, the similarity loss, the reconstruction loss and the diversity loss, update and iteration processing on the shared feature extractor and the shared predictor to obtain the target feature extractor and the target predictor comprises:
performing, using the health task loss, the similarity loss, the reconstruction loss, and the diversity loss, update processing on the shared feature extractor to obtain an updated shared feature extractor;
performing, according to the multiple pieces of source domain data, iterative training on the updated shared feature extractor until iteration is completed, to obtain the target feature extractor;
performing, using the health task loss, update processing on the shared predictor to obtain an updated shared predictor; and
performing, according to the multiple pieces of source domain data, iterative training on the updated shared predictor until the iteration is completed, to obtain the target predictor.

8. A domain generalization modelling device for industrial equipment health prediction, comprising:
a memory; and
a processor;
wherein the memory stores computer-executable instructions; and
the processor, when executing the computer-executable instructions stored on the memory, is configured to:
obtain multiple pieces of source domain data to be predicted, and input the multiple pieces of source domain data into a shared feature extractor to obtain a shared feature corresponding to each piece of source domain data, wherein industrial environments of the multiple pieces of source domain data are different;
input multiple shared features into a shared predictor to obtain a predicted health indicator corresponding to each piece of source domain data;
determine, according to multiple predicted health indicators, a health task loss for the multiple pieces of source domain data;
perform similarity processing on the multiple shared features to obtain a similarity loss for the multiple pieces of source domain data; and
perform, according to the multiple pieces of source domain data, based on the health task loss and the similarity loss, update and iteration processing on the shared feature extractor and the shared predictor to obtain a target feature extractor and a target predictor, and construct a health prediction model based on the target feature extractor and the target predictor.

9. The domain generalization modelling device for industrial equipment health prediction according to claim 8, wherein the device is further configured to:
obtain actual health indicators corresponding to the multiple pieces of source domain data;
determine, according to the multiple predicted health indicators and multiple actual health indicators, a prediction bias and a covariance corresponding to each piece of source domain data;
perform variance solving processing on prediction biases and covariances corresponding to the multiple pieces of source domain data to obtain a risk extrapolation parameter corresponding to the multiple pieces of source domain data; and
determine, according to the risk extrapolation parameter and the covariances corresponding to the multiple pieces of source domain data, a health task loss for the multiple pieces of source domain data.

10. The domain generalization modelling device for industrial equipment health prediction according to claim 9, wherein the device is further configured to:
determine, using the following formula, the similarity loss for the multiple pieces of source domain data:
$${ℒ}_{similarity} = - log {\sum }_{i} [ \frac{{\sum }_{k \neq i} - exp ( - τ \vert {y}_{i} - {y}_{k} \vert ) ‖ {H}_{i}^{{S}^{T}} {H}_{k}^{S} ‖}{{\sum }_{j \neq i} exp ( - τ \vert {y}_{i} - {y}_{j} \vert )} + ε ]$$
wherein [symbol] _{similarity} is the similarity loss for the multiple pieces of source domain data, yᵢ is an actual health indicator of the multiple pieces of source domain data corresponding to an i-th source domain data, yⱼ is an actual health indicator of the multiple pieces of source domain data corresponding to a j-th source domain data, yₖ is an actual health indicator of the multiple pieces of source domain data corresponding to a k-th source domain data,
$${H}_{i}^{S}$$
is used for indicating a shared feature of the multiple pieces of source domain data corresponding to an i-th source domain data,
$${H}_{k}^{S}$$
is used for indicating a shared feature of the multiple pieces of source domain data corresponding to a k-th source domain data, and τ and ε are hyperparameters determined through experiment.

11. The domain generalization modelling device for industrial equipment health prediction according to claim 8, wherein before performing, according to the multiple pieces of source domain data, based on the health task loss and the similarity loss, update and iteration processing on the shared feature extractor and the shared predictor to obtain the target feature extractor and the target predictor, the device is further configured to:
input the multiple pieces of source domain data into a private feature extractor to obtain a private feature corresponding to each piece of source domain data;
input multiple private features and the multiple shared features into a generator to obtain reconstructed data corresponding to the multiple pieces of source domain data;
determine, according to the reconstructed data and the multiple pieces of source domain data, a reconstruction loss for the multiple pieces of source domain data; and
perform, according to the multiple pieces of source domain data, based on the health task loss, the similarity loss and the reconstruction loss, update and iteration processing on the shared feature extractor and the shared predictor to obtain the target feature extractor and the target predictor.

12. The domain generalization modelling device for industrial equipment health prediction according to claim 11, wherein the device is further configured to:
determine, using the following equation, the reconstruction loss for the multiple pieces of source domain data:
$${ℒ}_{reconstruct} = {\sum }_{k = 1}^{K} \frac{1}{m} {‖ {X}_{k} - {\hat{X}}_{k} ‖}_{2}^{2} + \frac{1}{{m}^{2}} {( ( {X}_{k} - {\hat{X}}_{k} ) \cdot {1}_{m} )}^{2}$$
wherein [symbol] _{reconstruct} is the reconstruction loss for the multiple pieces of source domain data, K is a number of source domains of the multiple pieces of source domain data, m is a sequence length of each piece of source domain data, lₘ is a column vector with a length of m and all elements being 1, Xₖ is actual data of the multiple pieces of source domain data corresponding to a k-th source domain, and \hat{X}ₖ is reconstructed data of the multiple pieces of source domain data corresponding to the k-th source domain.

13. The domain generalization modelling device for industrial equipment health prediction according to claim 11, wherein before performing, according to the multiple pieces of source domain data, based on the health task loss and the similarity loss, update and iteration processing on the shared feature extractor and the shared predictor to obtain the target feature extractor and the target predictor, the device is further configured to:
perform diversity processing on the multiple private features and the multiple shared features to obtain a diversity loss corresponding to the multiple pieces of source domain data; and
perform, according to the multiple pieces of source domain data, based on the health task loss, the similarity loss, the reconstruction loss and the diversity loss, update and iteration processing on the shared feature extractor and the shared predictor to obtain the target feature extractor and the target predictor.

14. The domain generalization modelling device for industrial equipment health prediction according to claim 13, wherein the device is further configured to:
perform, using the health task loss, the similarity loss, the reconstruction loss, and the diversity loss, update processing on the shared feature extractor to obtain an updated shared feature extractor;
perform, according to the multiple pieces of source domain data, iterative training on the updated shared feature extractor until iteration is completed, to obtain the target feature extractor;
perform, using the health task loss, update processing on the shared predictor to obtain an updated shared predictor; and
perform, according to the multiple pieces of source domain data, iterative training on the updated shared predictor until the iteration is completed, to obtain the target predictor.

15. A non-transitory computer-readable storage medium, storing computer-executable instructions, which, when executed by a processor, cause the processor to perform operations comprising:
obtaining multiple pieces of source domain data to be predicted, and input the multiple pieces of source domain data into a shared feature extractor to obtain a shared feature corresponding to each piece of source domain data, wherein industrial environments of the multiple pieces of source domain data are different;
inputting multiple shared features into a shared predictor to obtain a predicted health indicator corresponding to each piece of source domain data;
determining, according to multiple predicted health indicators, a health task loss for the multiple pieces of source domain data;
performing similarity processing on the multiple shared features to obtain a similarity loss for the multiple pieces of source domain data; and
performing, according to the multiple pieces of source domain data, based on the health task loss and the similarity loss, update and iteration processing on the shared feature extractor and the shared predictor to obtain a target feature extractor and a target predictor, and constructing a health prediction model based on the target feature extractor and the target predictor.

16. The non-transitory computer-readable storage medium according to claim 15, wherein the determining, according to the multiple predicted health indicators, the health task loss for the multiple pieces of source domain data comprises:
obtaining actual health indicators corresponding to the multiple pieces of source domain data;
determining, according to the multiple predicted health indicators and multiple actual health indicators, a prediction bias and a covariance corresponding to each piece of source domain data;
performing variance solving processing on prediction biases and covariances corresponding to the multiple pieces of source domain data to obtain a risk extrapolation parameter corresponding to the multiple pieces of source domain data; and
determining, according to the risk extrapolation parameter and the covariances corresponding to the multiple pieces of source domain data, a health task loss for the multiple pieces of source domain data.

17. The non-transitory computer-readable storage medium according to claim 16, wherein the performing similarity processing on the multiple shared features to obtain the similarity loss for the multiple pieces of source domain data comprises:
determining, using the following formula, the similarity loss for the multiple pieces of source domain data:
$${ℒ}_{similarity} = - log {\sum }_{i} [ \frac{{\sum }_{k \neq i} - exp ( - τ \vert {y}_{i} - {y}_{k} \vert ) ‖ {H}_{i}^{{S}^{T}} {H}_{k}^{S} ‖}{{\sum }_{j \neq i} exp ( - τ \vert {y}_{i} - {y}_{j} \vert )} + ε ]$$
wherein [symbol] _{similarity} is the similarity loss for the multiple pieces of source domain data, yᵢ is an actual health indicator of the multiple pieces of source domain data corresponding to an i-th source domain data, yⱼ is an actual health indicator of the multiple pieces of source domain data corresponding to a j-th source domain data, yₖ is an actual health indicator of the multiple pieces of source domain data corresponding to a k-th source domain data,
$${H}_{i}^{S}$$
is used for indicating a shared feature of the multiple pieces of source domain data corresponding to an i-th source domain data,
$${H}_{k}^{S}$$
is used for indicating a shared feature of the multiple pieces of source domain data corresponding to a k-th source domain data, and τ and ε are hyperparameters determined through experiment.

18. The non-transitory computer-readable storage medium according to claim 15, wherein before performing, according to the multiple pieces of source domain data, based on the health task loss and the similarity loss, update and iteration processing on the shared feature extractor and the shared predictor to obtain the target feature extractor and the target predictor, the operations further comprise:
inputting the multiple pieces of source domain data into a private feature extractor to obtain a private feature corresponding to each piece of source domain data;
inputting multiple private features and the multiple shared features into a generator to obtain reconstructed data corresponding to the multiple pieces of source domain data;
determining, according to the reconstructed data and the multiple pieces of source domain data, a reconstruction loss for the multiple pieces of source domain data; and
wherein the performing, according to the multiple pieces of source domain data, based on the health task loss and the similarity loss, update and iteration processing on the shared feature extractor and the shared predictor to obtain the target feature extractor and the target predictor comprises:
performing, according to the multiple pieces of source domain data, based on the health task loss, the similarity loss and the reconstruction loss, update and iteration processing on the shared feature extractor and the shared predictor to obtain the target feature extractor and the target predictor.

19. The non-transitory computer-readable storage medium according to claim 18, wherein the determining, according to the reconstructed data and the multiple pieces of source domain data, the reconstruction loss for the multiple pieces of source domain data comprises:
determining, using the following equation, the reconstruction loss for the multiple pieces of source domain data:
$${ℒ}_{reconstruct} = {\sum }_{k = 1}^{K} \frac{1}{m} {‖ {X}_{k} - {\hat{X}}_{k} ‖}_{2}^{2} + \frac{1}{{m}^{2}} {( ( {X}_{k} - {\hat{X}}_{k} ) \cdot {1}_{m} )}^{2}$$
wherein [symbol] _{reconstruct} is the reconstruction loss for the multiple pieces of source domain data, K is a number of source domains of the multiple pieces of source domain data, m is a sequence length of each piece of source domain data, lₘ is a column vector with a length of m and all elements being 1, Xₖ is actual data of the multiple pieces of source domain data corresponding to a k-th source domain, and \hat{X}ₖ is reconstructed data of the multiple pieces of source domain data corresponding to the k-th source domain.

20. The non-transitory computer-readable storage medium according to claim 18, wherein before performing, according to the multiple pieces of source domain data, based on the health task loss and the similarity loss, update and iteration processing on the shared feature extractor and the shared predictor to obtain the target feature extractor and the target predictor, the operations further comprise:
performing diversity processing on the multiple private features and the multiple shared features to obtain a diversity loss corresponding to the multiple pieces of source domain data; and
wherein the performing, according to the multiple pieces of source domain data, based on the health task loss and the similarity loss, update and iteration processing on the shared feature extractor and the shared predictor to obtain the target feature extractor and the target predictor comprises:
performing, according to the multiple pieces of source domain data, based on the health task loss, the similarity loss, the reconstruction loss and the diversity loss, update and iteration processing on the shared feature extractor and the shared predictor to obtain the target feature extractor and the target predictor.
